(19) United States
(12) Patent Application Publication
(10) Pub. No.: US 2023/0143053 A1
(43) Pub. Date: May 11, 2023

(54) VIDEO ENCODING DEVICE, VIDEO DECODING DEVICE, VIDEO ENCODING METHOD, VIDEO DECODING METHOD, VIDEO SYSTEM, AND PROGRAM

(71) Applicant: NEC Corporation, Minato-ku, Tokyo (JP)

(72) Inventor: Keiichi CHONO, Tokyo (JP)

(73) Assignee: NEC Corporation, Minato-ku, Tokyo (JP)

(21) Appl. No.: 17/914,538

(22) PCT Filed: Apr. 1, 2020
(86) PCT No.: PCT/JP2020/015014

§ 371 Date: Sep. 26, 2022

(51) Int. Cl. H04N 19/33; H04N 19/132; H04N 19/172

(52) U.S. Cl. CPC H04N 19/33; H04N 19/132; H04N 19/172

(57) ABSTRACT

The video encoding device includes a multiplexer 11 which multiplexes a maximum image width and a maximum image height of a luminance sample of all frames into a bitstream; and a decision unit 12 which decides an image width and an image height of the luminance sample that is less than or equal to the maximum image width and the maximum image height, for each frame, wherein the multiplexer 11 multiplexes the decided image width and the decide image height of the luminance sample into a bitstream, the device further includes a deriving unit 13 which derives a reference picture scale ratio for scaling the image width and the image height of the luminance sample of the frame to be processed to the image width and the image height of the luminance sample of the frame processed in the past. cording to difficulty of video encoding of a scene.

### TECHNICAL FIELD

This invention relates to a video encoding device, a video decoding device, a video encoding method, a video decoding method, a video system and a program that use scaling of a reference picture.

### BACKGROUND ART

Non-patent literature 1 discloses the specification of VVC (Versatile Video encoding) which can approximately halve a bit rate with the same image quality as it of HEVC (High Efficiency Video encoding).

Non-patent literature 2 specifies video signal compression based on HEVC in digital broadcasting and introduces a concept of SOP (Set of Pictures). The SOP is a unit describing the encoding order and a reference relationship of each AU (Access Unit) in the case of performing temporal scalable encoding. As the structure, there are an L0 structure, an L1 structure, an L2 structure, an L3 structure, and an L4 structure.

By defining the SOP structure for the VVC, digital broadcasting can be operated for the VVC in a similar way to the HEVC.

### Citation List

### Non Patent Literature

NPL 1: “Versatile Video Coding (Draft 8)”, JVET-Q2001, Joint Video Experts Team (JVET) of ITU-T SG 16 WP 3 and ISO/IEC JTC ⅟SC 29/WG 11 17th Meeting: Brussels, BE, 7-17 January 2020
NPL 2: ARIB (Association of Radio Industries and Businesses) Standard STD-B32 3.11 edition, Jul. 26, 2018, Association of Radio Industries and Businesses
NPL 3: “Supplemental enhancement information for coded video bitstreams (Draft 3)”, JVET-Q2007, Joint Video Experts Team (JVET) of ITU-T SG 16 WP 3 and ISO/IEC JTC ⅟SC 29/WG 11 17th Meeting: Brussels, BE, 7-17 January 2020

### SUMMARY OF INVENTION

### Technical Problem

In Japan, the transmission capacity of the new 4K8K satellite broadcasting, which started in December 2018, is approximately 100 Mbps, and one 8K video is transmitted in HEVC. Therefore, even if the video bit rate can be halved by adopting VVC, it is difficult to maintain the quality of 8K video at an agreed service quality level (service level) in scenes with complex patterns and movements with the transmission capacity of approximately 40 Mbps for next-generation terrestrial broadcasting.

It is an object of the present invention to provide a video encoding device, video decoding device, video encoding method, video decoding method, video system, and program that can maintain high video quality of an ultra-high definition video.

### Solution to Problem

The video encoding device according to the present invention includes multiplexing means for multiplexing a maximum image width and a maximum image height of a luminance sample of all frames into a bitstream, and decision means for deciding an image width and an image height of the luminance sample that is less than or equal to the maximum image width and the maximum image height, for each frame, wherein the multiplexing means multiplexes the decided image width and the decide image height of the luminance sample into a bitstream, the device further comprising deriving means for deriving a reference picture scale ratio for scaling the image width and the image height of the luminance sample of the frame to be processed to the image width and the image height of the luminance sample of the frame processed in the past.

The video decoding device according to the present invention includes de-multiplexing means for de-multiplexing a maximum image width and a maximum image height of a luminance sample of all frames from a bitstream and de-multiplexing an image width and an image height of the luminance sample for each frame from the bitstream, deriving means for deriving a reference picture scale ratio for scaling the image width and the image height of the luminance sample of the frame to be processed to the image width and the image height of the luminance sample of the frame processed in the past, and scaling means for scaling an image size of the frame to be output for display to be the maximum image width and the maximum image height.

The video encoding method according to the present invention includes multiplexing a maximum image width and a maximum image height of a luminance sample of all frames into a bitstream, deciding an image width and an image height of the luminance sample that is less than or equal to the maximum image width and the maximum image height, for each frame, multiplexing the decided image width and the decide image height of the luminance sample into a bitstream, and deriving a reference picture scale ratio for scaling the image width and the image height of the luminance sample of the frame to be processed to the image width and the image height of the luminance sample of the frame processed in the past.

The video decoding method according to the present invention includes de-multiplexing a maximum image width and a maximum image height of a luminance sample of all frames from a bitstream, de-multiplexing an image width and an image height of the luminance sample for each frame from the bitstream, deriving a reference picture scale ratio for scaling the image width and the image height of the luminance sample of the frame to be processed to the image width and the image height of the luminance sample of the frame processed in the past, and scaling an image size of the frame to be output for display to be the maximum image width and the maximum image height.

The video encoding program according to the present invention causes a computer to execute a process of multiplexing a maximum image width and a maximum image height of a luminance sample of all frames into a bitstream, a process of deciding an image width and an image height of the luminance sample that is less than or equal to the maximum image width and the maximum image height, for each frame, a process of multiplexing the decided image width and the decide image height of the luminance sample into a bitstream, and a process of deriving a reference picture scale ratio for scaling the image width and the image height of the luminance sample of the frame to be processed to the image width and the image height of the luminance sample of the frame processed in the past.

The video decoding program according to the present invention causes a computer to execute a process of de-multiplexing a maximum image width and a maximum image height of a luminance sample of all frames from a bitstream, a process of de-multiplexing an image width and an image height of the luminance sample for each frame from the bitstream, a process of deriving a reference picture scale ratio for scaling the image width and the image height of the luminance sample of the frame to be processed to the image width and the image height of the luminance sample of the frame processed in the past, and a process of scaling an image size of the frame to be output for display to be the maximum image width and the maximum image height.

The video system according to the present invention includes the above video encoding device and the above video decoding device.

### Advantageous Effects of Invention

According to the present invention, the video quality of ultra-high definition video can be maintained at a high level.

### BRIEF DESCRIPTION OF DRAWINGS

FIG. 1 It depicts an explanatory diagram showing an example of 65 types of angular intra prediction.

FIG. 2 It depicts an explanatory diagram showing an example of inter-frame prediction.

FIG. 3 It depicts an explanatory diagram showing an example of CTU partitioning of a frame t and an example of CU partitioning of CTU8 of the frame t.

FIG. 4 It depicts a block diagram showing a configuration example of the video encoding device of the first example embodiment.

FIG. 5 It depicts a flowchart showing an operation of the encoding controller.

FIG. 6 It depicts a flowchart showing an operation of the video encoding device.

FIG. 7 It depicts an explanatory diagram showing the L2 structure of SOP.

FIG. 8 It depicts an explanatory diagram showing the L3 structure of SOP.

FIG. 9 It depicts an explanatory diagram showing the L4 structure of SOP.

FIG. 10 It depicts an explanatory diagram for explaining how to switch the image size according to a video encoding difficulty of a scene.

FIG. 11 It depicts a block diagram showing a configuration example of the video decoding device.

FIG. 12 It depicts a block diagram showing a configuration example of the video system.

FIG. 13 It depicts a block diagram depicting an example of a configuration example of the information processing system capable of realizing the functions of the video encoding device and the video decoding device.

FIG. 14 It depicts a block diagram showing a main part of the video encoding device.

FIG. 15 It depicts a block diagram showing a main part of the video decoding device.

### DESCRIPTION OF EMBODIMENTS

For the understanding of the following explanation, intra prediction, inter-frame prediction, as well as the coding tree unit (CTU: Coding Tree Unit) and the coding unit (CU: Coding Unit) are explained first.

Each frame of digitized video is split into CTUs, and each CTU is encoded in raster scan order.

Each CTU is split into CUs and encoded in a Quad-Tree (QT) or Multi-Tree (MT) structure.

Each CU is predictive-encoded. Predictive encoding includes intra prediction and inter-frame prediction. The prediction error of each CU is transform-encoded based on frequency transforming.

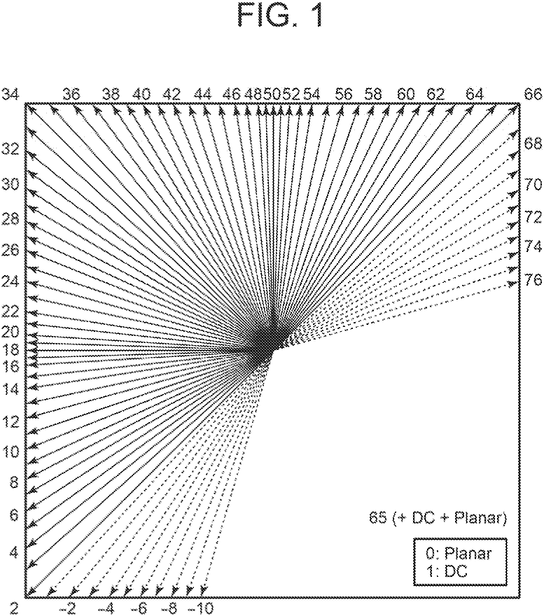

Intra prediction is prediction for generating a prediction image from a reconstructed image with the same display time as a frame to be encoded. Non-patent literature 1 defines 65 types of angular intra prediction shown in FIG. 1. In the angular intra prediction, a reconstructed pixel near a block to be encoded is used for extrapolation in any of 65 directions depicted in FIG. 1, to generate an intra prediction signal. In addition to the angular intra prediction, non-patent literature 1 defines DC intra prediction for averaging reconstructed pixels near the block to be encoded, and Planar intra prediction for linear interpolating reconstructed pixels near the block to be encoded. A CU encoded based on intra prediction is hereafter referred to as an intra CU.

Inter-frame prediction is prediction based on an image of a reconstructed frame (reference picture) different in display time from a frame to be encoded. Inter-frame prediction is hereafter also referred to as inter prediction.

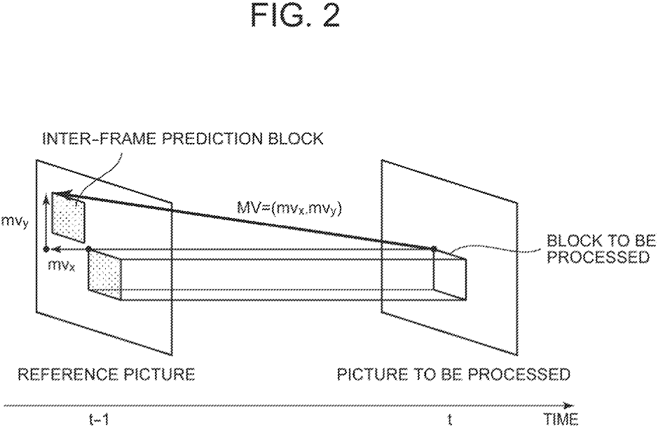

FIG. 2 is an explanatory diagram depicting an example of inter-frame prediction. A motion vector MV = (mvₓ, mv_{y}) indicates an amount of translation of a reconstructed image block of a reference picture relative to a block to be encoded. In inter prediction, an inter prediction signal is generated based on a reconstructed image block of a reference picture (using pixel interpolation if necessary). A CU encoded based on inter-frame prediction is hereafter referred to as an inter CU.

A frame encoded including only intra CUs is called an I frame (or I picture). A frame encoded including not only intra CUs but also inter CUs is called a P frame (or P picture). A frame encoded including inter CUs that each use not only one reference picture but two reference pictures simultaneously for the inter prediction of the block is called a B frame (or B picture).

Inter prediction using one reference picture is called one-directional prediction, and inter prediction using two reference pictures simultaneously is called bi-directional prediction.

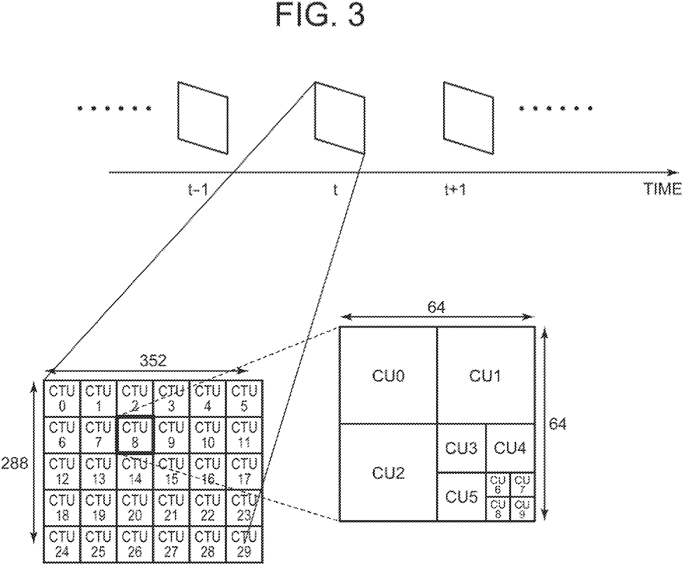

FIG. 3 is an explanatory diagram showing an example of CTU partitioning of a frame t in the case where the number of pixels is CIF (Common Intermediate Format) and the CTU size is 64, and an example of partitioning of the eighth CTU (CTU8) included in the frame t.

Hereinafter, example embodiments of the present invention will be described with reference to the drawings.

### Example Embodiment 1

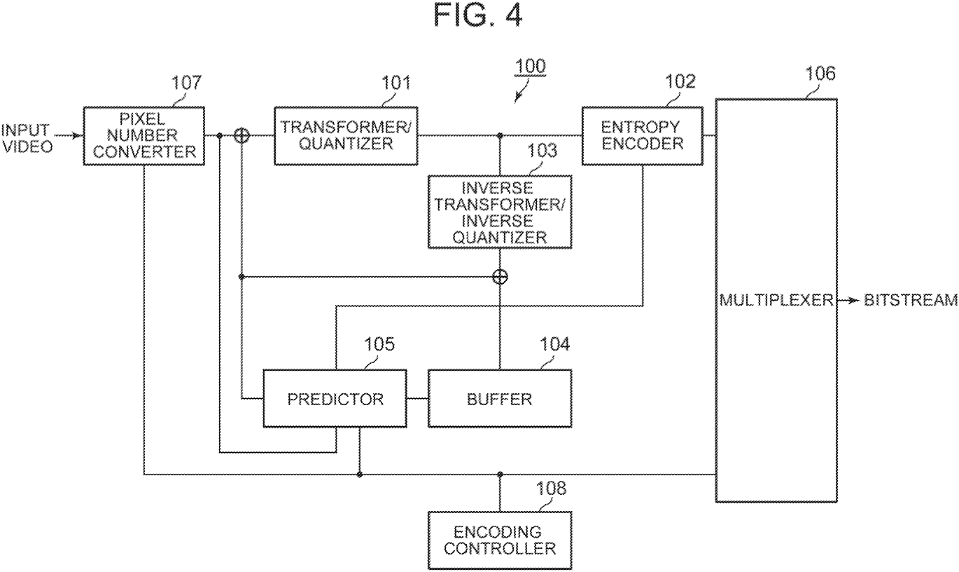

FIG. 4 is a block diagram showing an example configuration of the video encoding device of the first example embodiment. The video encoding device 100 of this example embodiment comprises a transformer/quantizer 101, an entropy coder 102, an inverse transformer/inverse quantizer 103, a buffer 104, a predictor 105, a multiplexer 106, a pixel number converter 107, and an encoding controller 108.

The encoding controller 108 controls the pixel number converter 107, etc. The pixel number converter 107 has a function of converting an image size of the input video to the pixel size determined by the encoding controller 108.

A frame (image signal) of an ultra-high definition video is input to the pixel number converter 107. The transformer/quantizer 101 frequency-transforms a prediction error image obtained by subtracting a prediction signal from the image signal supplied by the pixel number converter 107 to obtain a frequency transform coefficient. Further, the transformer/quantizer 101 quantizes the frequency-transformed prediction error image (frequency transform coefficient) with a predetermined quantization step size. Hereafter, the quantized frequency transform coefficient is referred to as the transform quantization value.

The entropy encoder 102 entropy-encodes the value of cu_split_flag syntax, the value of pred_mode_flag syntax, an intra prediction direction, difference information of the motion vector, and the transform quantization value.

The inverse transformer/inverse quantizer 103 inverse-quantizes the transform quantization value with a predetermined quantization step size. In addition, the inverse transformer/inverse quantizer 103 inverse-frequency-transforms the frequency transform coefficient obtained by the inverse quantization. A reconstructed prediction error image obtained by the inverse frequency transforming is supplied to the buffer 104 after the prediction signal is added.

The multiplexer 106 multiplexes and outputs the output data of the entropy encoder 102.

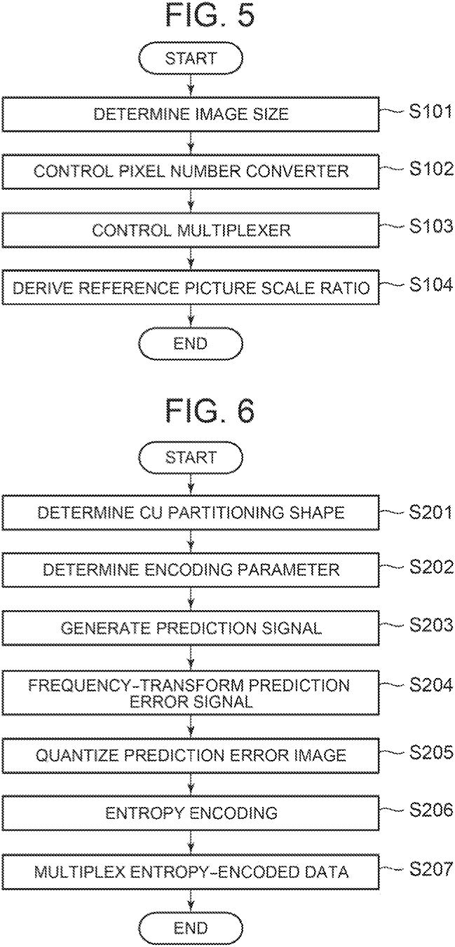

Next, the operation of the encoding controller 108 in the video encoding device 100 will be described with reference to the flowchart of FIG. 5. The case in which the input video, which is an ultra-high definition video input to the pixel number converter 107, is an 8K video (7680 horizontal pixels and 4320 vertical pixels) is used as an example.

The encoding controller 108 determines an image size of the image frame to be processed (frame to be processed) (step S101). The method of determination is described below.

The encoding controller 108 controls the operation of the pixel number converter 107 for the frame to be processed based on the determined image size (step S102).

When the frame to be processed is processed as 8K video, the encoding controller 108 controls the pixel number converter 107 so that an image size of the frame output by the pixel number converter 107 is 8K (7680 horizontal pixels and 4320 vertical pixels) as it is. In other words, the encoding controller 108 gives a command to the pixel number converter 107 indicating that the pixel number converter 107 should do so. Otherwise (when processing as 4K video), the encoding controller 108 makes an image size of the output frame of the pixel number converter 107 to be 4K (3840 horizontal pixels and 2160 vertical pixels). In other words, the encoding controller 108 gives a command to the pixel number converter 107 indicating that the pixel number converter 107 should do so. The pixel number converter 107 reduces the number of pixels in the frame according to the command.

Next, the encoding controller 108 controls the multiplexer 106 based on the determined image size (step S103). The encoding controller 108 controls the multiplexer 106 as follows, for example.

The encoding controller 108 controls the multiplexer 106 so that the value of pic_width_max_in_luma_samples syntax (corresponding to the maximum image width of a luminance sample) and the value of pic_height_max_in_luma_samples syntax (corresponding to the maximum image height of a luminance sample) in a sequence parameter set output by the multiplexer 106 become to be 7680 and 4320, respectively. In other words, the encoding controller 108 gives a command to the multiplexer 106 indicating that the multiplexer 106 should do so.

When the frame to be processed is processed as an 8K video, the encoding controller 108 controls the multiplexer 106 so that the value of pic_width_in_luma_samples syntax (corresponding to the image width of a luminance sample) and the value of pic_height_in_luma_samples syntax (corresponding to the image height of a luminance sample) in the picture parameter set of the frame to be processed output by the multiplexer 106 become to be 7680 and 4320, respectively. In other words, the encoding controller 108 gives a command to the multiplexer 106 indicating that the multiplexer 106 should do so.

Otherwise (when processing as 4K video), the encoding controller 108 controls the multiplexer 106 so that the value of pic _width_in_luma_samples syntax (corresponding to the image width of a luminance sample) and the value of pic_height__in_luma_samples syntax (corresponding to the image height of a luminance sample) in the picture parameter set of the frame to be processed output by the multiplexer 106 become to 3840 and 2140, respectively. In other words, the encoding controller 108 gives a command to the multiplexer 106 indicating that the multiplexer 106 should do so.

The multiplexer 106 multiplexes the values of pic_width_max_in_luma_samples syntax and the values of pic_height__max_in_luma_samples syntax for all frames into a bitstream according to the control of encoding controller 108. The multiplexer 106 also multiplexes the value of pic _width_in_luma_samples syntax and the value of pic _height__in_luma_samples syntax for each frame into the bitstream.

Further, the encoding controller 108 derives a reference picture scale ratio RefPicScale for each frame processed in the past so as to scale the image size of the frame to be processed to the image size of the frame processed in the past, and supplies RefPicScale to the predictor 105 (step S104).

RefPicScale is expressed by the following equation described in 8.3.2 Decoding process for reference picture lists construction in Non-patent literature 1.

$$\begin{matrix}\text{RefPicScale[ i ][ j ][ 0 ] = ( ( fRefWidth << 14 ) + ( PicOutputWidthL >> 1 ) ) /} \\ \text{PicOutputWidthL} \\ \text{RefPicScale[ i ][ j ][ 1 ] = ( ( fRefWidth << 14 ) + ( PicOutputWidthL >> 1 ) ) /} \\ \text{PicOutputHeightL}\end{matrix}$$

In this regard, PicOutputWidthL = pic_width_in_luma_samples and PicOutputHeightL = pic_height_in_luma_samples, and fRefWidth and fRefHeight are the values of pic_width_in_luma_samples syntax and pic_height__in_luma_samples syntax set for the frame to be processed in the past, respectively.

As can be seen from equation (1), the reference picture scale ratio is a ratio of the image size of the frame processed in the past to the image size of the frame to be processed.

Next, the whole operation of the video encoding device 100 will be described with reference to the flowchart of FIG. 6.

The predictor 105 performs predictive encoding. That is, for each CTU, the predictor 105 first determines the value of cu_split_flag syntax that determines the CU partitioning shape that minimizes the encoding cost (step S201). Next, for each CU, the predictor 105 determines encoding parameters (the value of pred_mode_flag syntax that determines intra prediction or inter prediction, the intra prediction direction, and the difference information of the motion vector, etc.) that minimize encoding cost are determined (step S202).

Further, the predictor 105 generates a prediction signal for the input image signal of each CU based on the determined value of cu_split_flag syntax, the determined value of pred _mode_flag syntax, the determined intra prediction direction, the determined motion vector, the determined reference picture scale ratio, etc. (step S203). The prediction signal is generated based on intra prediction or inter-frame prediction.

The pixel number converter 107 scales the frame to be processed to the image size determined by the encoding controller 108, as described above.

The transformer/quantizer 101 frequency-transforms a prediction error image obtained by subtracting a prediction signal from the image signal supplied by the pixel number converter 107 (step S204). Further, the transformer/quantizer 101 quantizes the frequency-transformed prediction error image (frequency transform coefficient) (step S205).

The entropy encoder 102 entropy-encodes the value of cu_split_flag syntax , the value of pred_mode_flag syntax, the intra prediction direction, the difference information of the motion vector, and the quantized frequency transform coefficient (transform quantization value) which are determined by the predictor 105 (step S206).

The multiplexer 106 multiplexes and outputs the entropy-encoded data supplied from the entropy encoder 102 as a bitstream (step S207).

The inverse transformer/inverse quantizer 103 inverse-quantizes the transform quantization value. In addition, the inverse transformer/inverse quantizer 103 inverse-frequency-transforms the frequency transform coefficient obtained by the inverse quantization. The reconstructed prediction error image obtained by the inverse frequency transforming is supplied to the buffer 104 after the prediction signal is added. The buffer 104 sores the reconstructed image.

By the operations described above, the video encoding device generates a bitstream.

### Example of How to Determine Image Size

As an example of how to determine the image size, the following explains how to switch the image size of the frame to be processed between 8K and 4K according to the Temporal ID of the SOP structure. The Temporal ID of the AU is a value obtained by subtracting 1 from nuh_temporal_id_plus1 in the NALU (Network Abstraction Layer Unit) header in the AU.

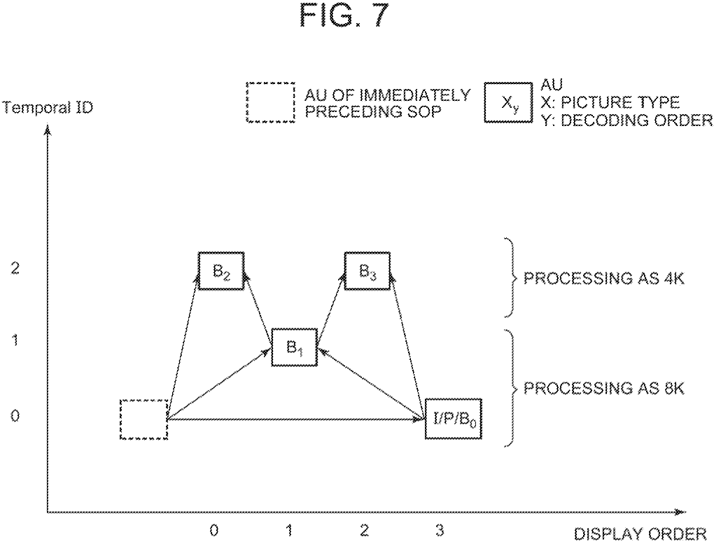

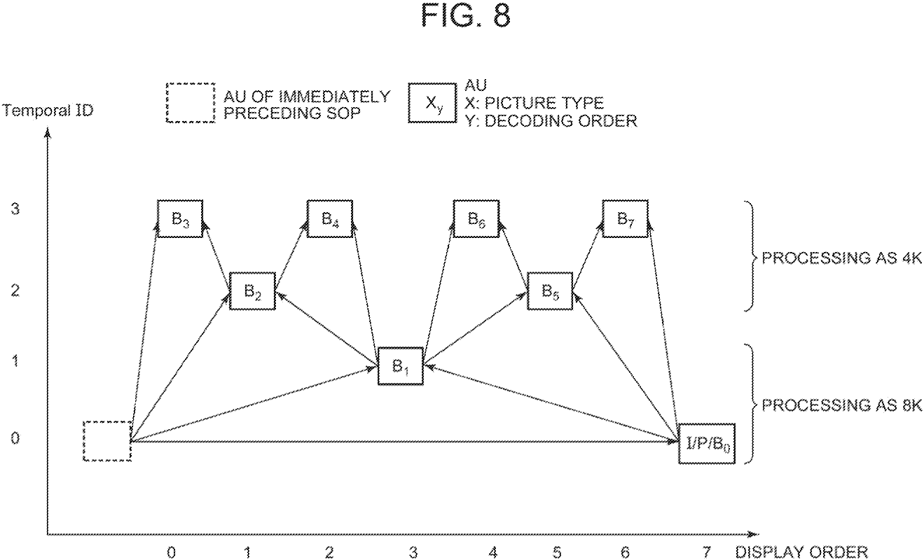

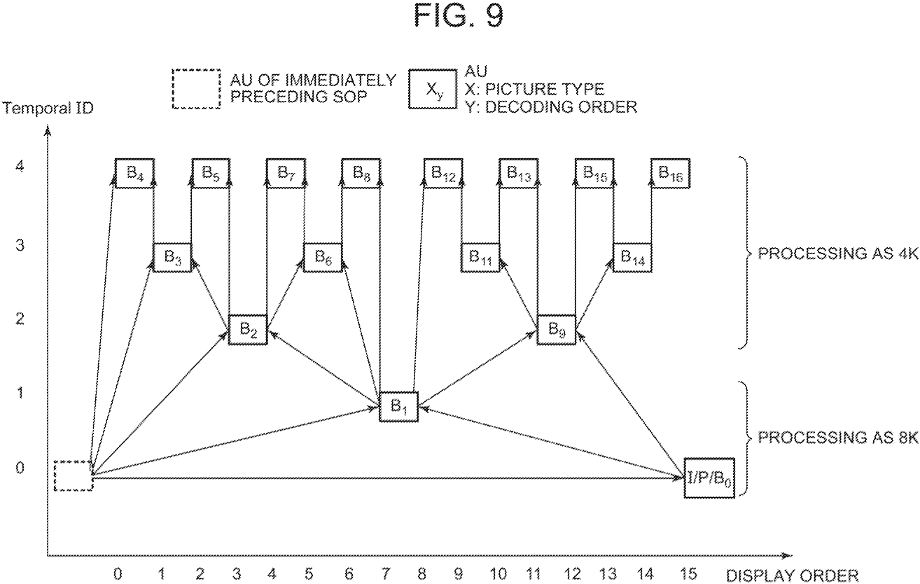

FIG. 7 is an explanatory diagram showing the L2 structure of SOP. FIG. 8 is an explanatory diagram showing the L3 structure of SOP. FIG. 9 is an explanatory diagram showing the L4 structure of SOP.

Specifically, FIGS. 7 to 9 show examples in which frames included in AUs whose Temporal ID values is equal to or greater than a predetermined threshold are set to a smaller image size (4K) and frames in other AUs are set to unchanged image size (8K). In this regard, FIGS. 7 to 9 illustrate the case where the predetermined threshold value is 2.

When the video encoding device is configured to switch between 8K and 4K as described above, an afterimage effect due to the periodic display of 8K images with higher resolution can be obtained. In other words, the high definition of 8K images can be perceived. In addition, since the amount of data is reduced in frames using 4K, degradation caused by video encoding is prevented even in scenes with complex patterns or movements. In other words, video quality can be maintained at a high level. Further, since there is no need to re-entrain the video bitstream at the receiving terminal side such as a video decoding device, the video can be reproduced smoothly at the receiving terminal side even if the image size is switched.

It should be noted that 2 as a threshold value for the Temporal ID value to determine the AU that executes processing with the smaller image size described above is an example, and other values may be used.

When video encoding is easy, for example, the encoding controller 108 may also make frames included in AUs with Temporal ID values which are equal or greater than a predetermined threshold unchanged image size. In other words, the encoding controller 108 may set the frames included in AUs with Temporal ID values which are equal or greater than the predetermined threshold to unchanged or smaller image size, and always set the frames in other AUs to unchanged image size.

Further, for the purpose of favorably obtaining an afterimage effect, it is desirable to process frames included in AUs that include I-pictures with Temporal ID values less than a predetermined threshold with a larger image size than the other frames. On the other hand, for the purpose of maximizing the data volume reduction effect, it is desirable that the image size of frames, included in AUs with Temporal ID values are equal to or greater than a predetermined threshold value, is greater than than that of frames included in AUs with Temporal ID values are less than the predetermined threshold value.

### Another Example of How Image Size Is Determined

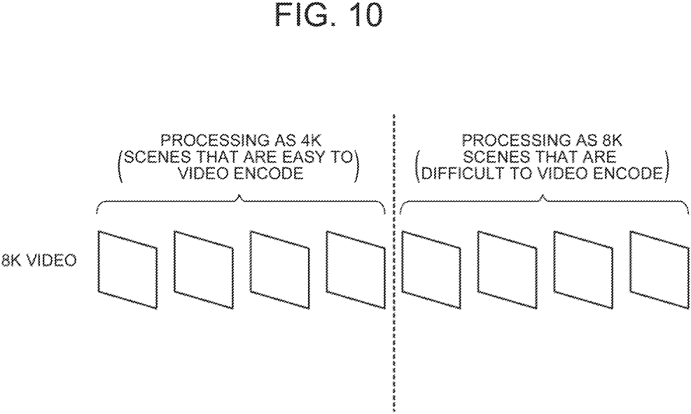

As another example of how to determine the image size, a method is considered that the encoding controller 108 switches the image size of the frame to be processed between 8K and 4K, as illustrated in FIG. 10, according to the difficulty of the video encoding of the scene.

The difficulty of video encoding can be determined based on a result of monitoring the characteristics of the input video (complexity of patterns or movements, etc.) or output characteristics of the entropy encoder 102 (such as quantization coarseness).

So as to absorb the difference in picture quality at the joint of switching between 4K and 8K, it is desirable to use the frame before switching as the reference picture in the leading picture of the first I-picture after the switching. This is because a smoothing effect can be obtained by bi-directional prediction combining 4K and 8K images when generating a prediction image for the leading picture.

Further, it is desirable to process the leading picture after switching to 8K by 4K for the purpose of reducing data volume. On the other hand, for the purpose of maximizing the smoothing effect, it is desirable to process by 8K.

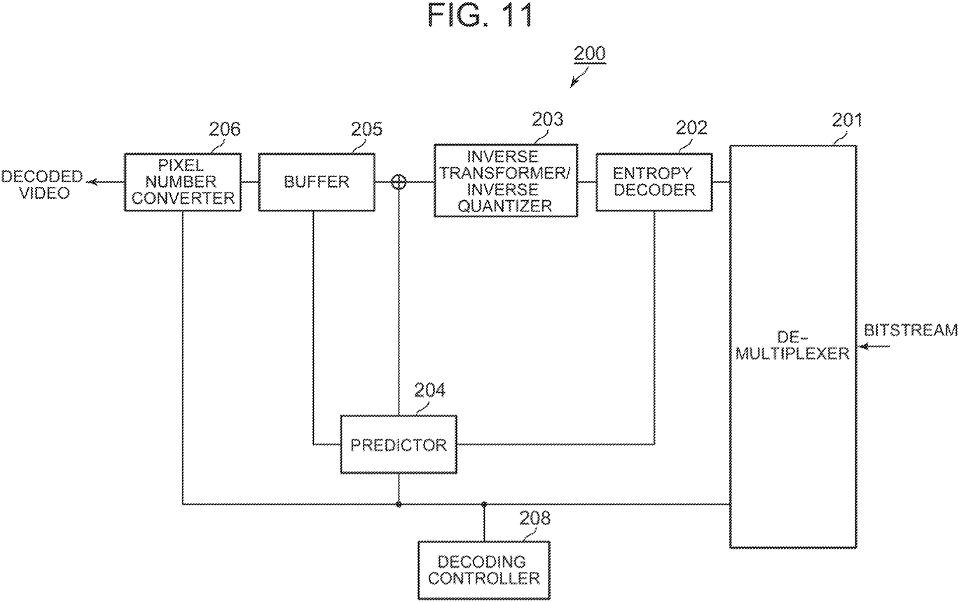

Next, the configuration and the operation of the video decoding device will be explained. FIG. 11 is a block diagram showing a configuration example of the video decoding device of this example embodiment. The video decoding device 200 shown in FIG. 11 is capable of receiving a bitstream from the video encoding device 10 shown in FIG. 4 and executing video decoding processing. However, the transmission source of the bitstream is not limited to the video encoding device 100 shown in FIG. 4.

The video decoding device shown in FIG. 11 comprises a de-multiplexer 201, an entropy decoder 202, an inverse transformer/inverse quantizer 203, a predictor 204, a buffer 205, a pixel number converter 206, and a decoding controller 208.

The de-multiplexer 201 demultiplexes an input bitstream to extract entropy-encoded data.

The entropy decoder 202 entropy-decodes the entropy-encoded data. The entropy decoder 202 supplies an entropy-decoded transform quantization value to the inverse transformer/inverse quantizer 203, and also supplies cu_split_flag, pred_mode_flag, an intra prediction direction, and a motion vector to the predictor 204.

In this example embodiment, the bitstream is multiplexed with data (for example, the value of pic_width_max_in_luma_samples syntax and the value of pic_height_max_in_luma_samples syntax) representing the maximum image width and the maximum image height of a luminance sample for all frames. The bitstream is also multiplexed with data (for example, the value of pic_width_in_luma_samples syntax and the value of pic_height_in_luma_samples syntax) representing the image width and the image height of the luminance sample for each frame. The entropy decoder 202 supplies those data which are entropy-decoded to the decoding controller 208.

The decoding controller 208, for example, based on equation (1), derives the reference picture scale ratio RefPicScale for each frame from the value of pic_width_in_luma_samples syntax and the value of pic_height__in_luma_samples syntax. The decoding controller 208 supplies the reference picture scale ratio RefPicScale for each frame to the predictor 204. The decoding controller 208 also supplies the value of pic_width_max_in_luma_samples syntax, the value of pic_height_max _in_luma_samples syntax, the value of pic _width_in_luma_samples syntax and the value of pic _height__in_luma_samples syntax to the pixel number converter 206.

The inverse transformer/inverse quantizer 203 inverse-quantizes the transform quantization value with a predetermined quantization step size. In addition, the inverse transformer/inverse quantizer 203 inverse-frequency-transforms the frequency transform coefficient obtained by the inverse quantization.

The predictor 204 generates a prediction signal based on the cu_split_flag, the pred_mode_flag, the intra prediction direction, the motion vector, and the reference picture scale ratio RefPicScale. The prediction signal is generated based on intra prediction or inter-frame prediction.

A reconstructed prediction error image obtained by the inverse frequency transforming in the inverse transformer/inverse quantizer 203 is supplied to the buffer 205 after the prediction signal supplied by the predictor 204 is added as a reconstructed picture. The reconstructed picture stored in the buffer 205 is then output as a decoded video.

By the operations described above, the video decoding device of this example embodiment generates the decoded video.

The decoded video data is supplied to a display device or a storage device as video data for display, and the pixel number converter 206 scales each of the decoded video data to a predetermined image width and image height so that the image sizes of all video data for display are made the same size. For example, a maximum image width and maximum image height can be used as the predetermined image width and image height. In this case, the pixel number converter 206 can derive the ratio for the above scale using the value of pic_width_in_luma_samples syntax, the value of pic_height_max_in_luma_samples syntax, the value of pic_width_max_in_luma_samples syntax, and the value of pic_height_in_luma_samples syntax.

In this example embodiment, the image size of the reconstructed image frame may differ from frame to frame. Therefore, in this example embodiment, for the purpose of making the displayed images the same size, the pixel number converter 206 in the video decoding device 200 is configured to convert the size so that the size of the reconstructed image frame becomes to be a size indicated by the value of pic _width_max_in_luma_samples syntax and the value of pic _height_max_in_luma_samples syntax in the sequence parameter set. Therefore, the video can be reproduced smoothly even if the image size is switched.

As explained above, in this example embodiment, the video encoding device encodes video while switching the size of the image so that video quality is maintained at the service level even in scenes with complex patterns or movements. In addition, the video encoding device uses scaling of a reference picture in video encoding so that re-entraining of the video bitstream due to switching of the image size becomes unnecessary at a receiving terminal such as a video decoding device. Further, the video encoding device can control the video encoding so that the switching of the image size is visually less noticeable.

Therefore, the video quality is maintained at the service level even in scenes with complex patterns or movements. In addition, re-entraining of the video bitstream is not required at a receiving terminal side, and the video can be reproduced smoothly even if the image size is switched. Further, since the change of image size is less visually noticeable, the video quality at the moment of change of image size can be maintained at the service level.

In the above example embodiment, when the input video is 8K video, 8K video (7680 horizontal pixels and 4320 vertical pixels) and 4K video (3840 horizontal pixels and 2160 vertical pixels) are switched with the same aspect ratio, however as another example embodiment, the aspect ratio can be switched.

For example, it may switch between 8K video with an aspect ratio of 16:9 (7680 horizontal pixels and 4320 vertical pixels) and 8K video with an aspect ratio of 4:3 (5760 horizontal pixels and 4320 vertical pixels). However, in this case, the VUI (Video Usability Information) and Sample aspect ratio information SEI (Supplemental Enhancement Information) message will be as follows.

### VUI

The value of the vui_aspect_ratio_constant_flag included in VUI is 0.

### Sample Aspect Ratio Information SEI Message

Each AU includes the Sample aspect ratio information SEI message.

In order that reproduced images of AU encoded in different aspect ratios are displayed in the same size, the pixel aspect represented by the sari_aspect_ratio_idc, sari_sar_width, sari_sar_height of the SEI message of the AU encoded in the image size of one aspect ratio is different value from the sari_aspect_ratio_idc, sari_sar_width, sari _sar_height of the SEI message of the AU encoded in the image size of the other aspect ratio.

In the above example, when vui_aspect_ratio_idc is 1, the sari_aspect_ratio_idc of the AU SEI message encoded in 8K video with an aspect ratio of 16:9 is 1, and sari_aspect_ratio_idc of the SEI message of the AU encoded in 8K video with an aspect ratio 4:3 is 14.

### Example Embodiment 2

FIG. 12 is a block diagram showing a configuration example of the video system. The video system shown in FIG. 12 is a system in which the above video encoding device 100 and the above video decoding device 200 are connected by a wireless transmission channel or a wired transmission channel 300.

In the video system 300, the video encoding device 100 can generate a bitstream as described above. In addition, in the video system 300, the video decoding device 200 can decode a bitstream as described above.

Each component in each of the above example embodiments may be configured with hardware, however can also be configured with a computer program.

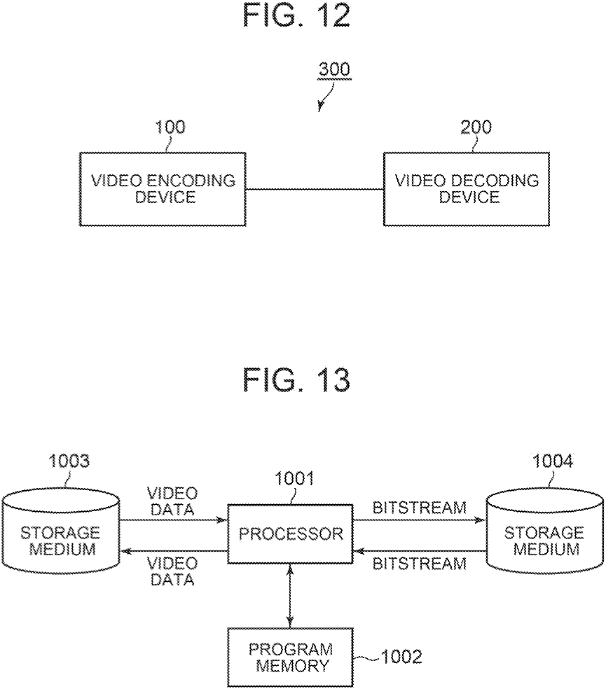

The information processing system shown in FIG. 13 comprises a processor 1001 including a CPU, a program memory 1002, a storage medium 1003 for storing video data and a storage medium 1004 for storing bitstreams. The storage medium 1003 and the storage medium 1004 may be separate storage media, or they may be storage areas in a single storage medium. A magnetic storage medium such as a hard disk can be used as the storage medium.

In the information processing system shown in FIG. 13, the program memory 1002 stores a program (video encoding program or video decoding program) to realize the function of the video encoding device or the video decoding device shown in FIGS. 4 and 11, respectively.

Some of the functions in the video encoding device or the video decoding device shown in FIGS. 4 and 11, respectively, may be realized in a semiconductor integrated circuit, while other parts may be realized in the processor 1001 or the like.

The program memory 1002 is, for example, a non-transitory computer readable media. The non-transitory computer readable medium is one of various types of tangible storage media. Specific examples of the non-transitory computer readable media include a semiconductor memory, a magnetic storage medium (for example, hard disk), a magneto-optical storage medium (for example, magneto-optical disk).

The program may be stored in various types of transitory computer readable media. The transitory computer readable medium (for example, a flash ROM) is supplied with the program through, for example, a wired or wireless communication channel, i.e., through electric signals, optical signals, or electromagnetic waves.

FIG. 14 is a block diagram showing a main part of the video encoding device. The video encoding device 10 shown in FIG. 14 comprises a multiplexer (multiplexing means) 11 (in the example embodiments, realized by the multiplexer 106) which multiplexes a maximum image width (specifically, data representing the maximum image width, for example, pic _width_max_in_luma_samples syntax) and a maximum image height (specifically, data representing the maximum image height, for example, pic _height_max_in_luma_samples syntax) of a luminance sample of all frames into a bitstream, and a decision unit (decision means) 12 (in the example embodiments, realized by the encoding controller 108) which decides an image width (specifically, data representing the width of the image, for example, pic_width_in_luma_samples syntax) and an image height (specifically, data representing the height of the image, for example, pic _height_in _luma_samples syntax) of the luminance sample that is less than or equal to the maximum image width and the maximum image height, for each frame, wherein the multiplexer 11 multiplexes the decided image width and the decide image height of the luminance sample into a bitstream, the device further includes a deriving unit (deriving means) 13 (in the example embodiments, realized by the encoding controller 108) which derives a reference picture scale ratio for scaling the image width and the image height of the luminance sample of the frame to be processed to the image width and the image height of the luminance sample of the frame processed in the past.

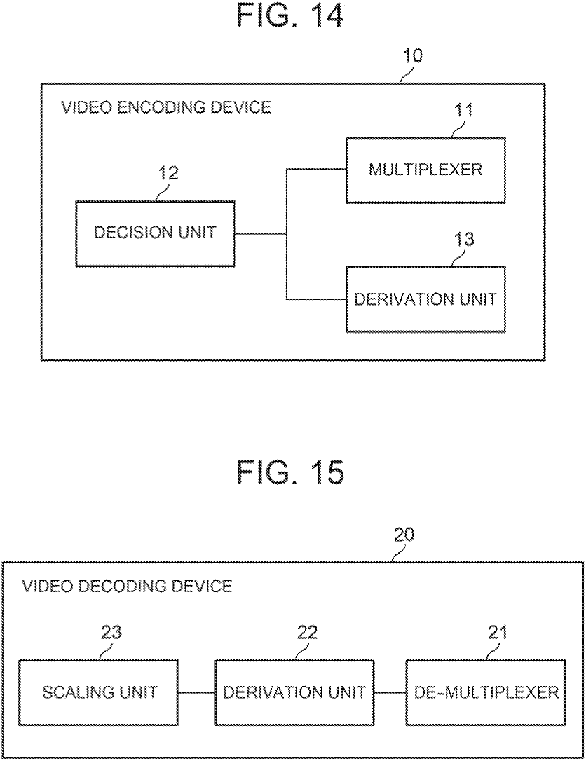

FIG. 15 is a block diagram showing a main part of the video decoding device. The video decoding device 20 shown in FIG. 15 comprises a de-multiplexer (de-multiplexing means) 21 (in the example embodiments, realized by the de-multiplexer 201) which de-multiplexes a maximum image width and a maximum image height of a luminance sample of all frames from a bitstream and de-multiplexing an image width and an image height of the luminance sample for each frame from the bitstream, a deriving unit (deriving means) 22 (in the example embodiments, realized by the decoding controller 208) which derives a reference picture scale ratio for scaling the image width and the image height of the luminance sample of the frame to be processed to the image width and the image height of the luminance sample of the frame processed in the past, and scaling unit (scaling means) 23 (in the example embodiments, realized by the pixel number converter 206) which scales an image size of the frame to be output for display to be the maximum image width and the maximum image height, based on information relative to the reference picture scale ratio (for example, the reference picture scale ratio RefPicScale itself or a syntax value for deriving the reference picture scale ratio RefPicScale).

A part of or all of the above example embodiments may also be described as, but not limited to, the following supplementary notes.

(Supplementary note 1) A computer readable recording medium in which a video encoding program is recorded, wherein
the video encoding program causes a computer to execute
a process of multiplexing a maximum image width and a maximum image height of a luminance sample of all frames into a bitstream,
a process of deciding an image width and an image height of the luminance sample that is less than or equal to the maximum image width and the maximum image height, for each frame,
a process of multiplexing the decided image width and the decide image height of the luminance sample into a bitstream, and
a process of deriving a reference picture scale ratio for scaling the image width and the image height of the luminance sample of the frame to be processed to the image width and the image height of the luminance sample of the frame processed in the past.

(Supplementary note 2) A computer readable recording medium in which a video decoding program is recorded, wherein
the video decoding program causes a computer to execute
a process of de-multiplexing a maximum image width and a maximum image height of a luminance sample of all frames from a bitstream
a process of de-multiplexing an image width and an image height of the luminance sample for each frame from the bitstream,
a process of deriving a reference picture scale ratio for scaling the image width and the image height of the luminance sample of the frame to be processed to the image width and the image height of the luminance sample of the frame processed in the past, and
a process of scaling an image size of the frame to be output for display to be the maximum image width and the maximum image height.

Although the invention of the present application has been described above with reference to example embodiments, the present invention is not limited to the above example embodiments. Various changes can be made to the configuration and details of the present invention that can be understood by those skilled in the art within the scope of the present invention.

### Reference Signs List

10, 100 Video encoding device
11 Multiplexer
12 Decision unit
13 Derivation unit
20, 200 Video decoding device
21 De-multiplexer
22 Derivation unit
23 Scaling unit
101 Transformer/quantizer
102 Entropy encoder
103 Inverse transformer/inverse quantizer
104 Buffer
105 Predictor
106 Multiplexer
107 Pixel number converter
108 Encoding controller
201 De-multiplexer
202 Entropy decoder
203 Inverse transformer/inverse quantizer
204 Predictor
205 Buffer
206 Pixel number converter
208 Decoding controller
300 Video system
1001 Processor
1002 Program memory
1003, 1004 Storage media

What is claimed is:

1. A video encoding device comprising:
a memory storing software instructions; and
one or more processors configured to execute the software instructions to,
multiplex a maximum image width and a maximum image height of a luminance sample of all frames into a bitstream; and
decide an image width and an image height of the luminance sample that is less than or equal to the maximum image width and the maximum image height, for each frame,
multiplex the decided image width and the decide image height of the luminance sample into a bitstream, and
derive a reference picture scale ratio for scaling the image width and the image height of the luminance sample of the frame to be processed to the image width and the image height of the luminance sample of the frame processed in the past.

2. The video encoding device according to claim 1,
wherein the one or more processors are configured to further execute to generate a prediction signal also using the reference picture scale ratio.

3.The video encoding device according to claim 1, wherein
the one or more processors are configured to switch an image size of the frame between 8K and 4K according to the Temporal ID of a SOP structure.

4. The video encoding device according to claim 1, wherein
the one or more processors are configured to switch an image size of the frame between 8K and 4K according to difficulty of video encoding of a scene.

5. A video decoding device comprising:
a memory storing software instructions; and
one or more processors configured to execute the software instructions to,
de-multiplex a maximum image width and a maximum image height of a luminance sample of all frames from a bitstream and de-multiplexing an image width and an image height of the luminance sample for each frame from the bitstream;
derive a reference picture scale ratio for scaling the image width and the image height of the luminance sample of the frame to be processed to the image width and the image height of the luminance sample of the frame processed in the past; and
scale an image size of the frame to be output for display to be the maximum image width and the maximum image height.

6. A video encoding method, implemented by a processor, comprising:
multiplexing a maximum image width and a maximum image height of a luminance sample of all frames into a bitstream;
deciding an image width and an image height of the luminance sample that is less than or equal to the maximum image width and the maximum image height, for each frame;
multiplexing the decided image width and the decide image height of the luminance sample into a bitstream; and
deriving a reference picture scale ratio for scaling the image width and the image height of the luminance sample of the frame to be processed to the image width and the image height of the luminance sample of the frame processed in the past.

7-10. (canceled)

11. The video encoding device according to claim 2, wherein
the one or more processors are configured to switch an image size of the frame between 8K and 4K according to the Temporal ID of a SOP structure.

12. The video encoding device according to claim 2, wherein
the one or more processors are configured to switch an image size of the frame between 8K and 4K according to difficulty of video encoding of a scene.
